(19) United States
(12) Patent Application Publication
(10) Pub. No.: US 2009/0244775 A1
(43) Pub. Date: Oct. 1, 2009

(54) ADJACENT-TRACK-ERASURE (ATE) REFRESH WITH INCREASED TRACK RESOLUTION FOR OFTEN-WRITTEN AREAS

(75) Inventor: Richard M. Ehrlich, Saratoga, CA (US)

Correspondence Address: SCHWEGMAN, LUNDBERG & WOESSNER/TOSHIBA, P.O. BOX 2938, MINNEAPOLIS, MN, 55402, US

(73) Assignee: Kabushiki Kaisha Toshiba 1-1, Tokyo (JP)

(21) Appl. No.: 12/060,067

(22) Filed: Mar. 31, 2008

(51) Int. Cl. G11B 5/82; G11B 5/55

(52) U.S. Cl. 360/135; 360/260

(57) ABSTRACT

Methods and systems are shown that specify using group counters and track counters to reduce the need for adjacent-track-erasure (ATE) refresh. A group threshold may be used to monitor the number of write operations to a group. The group threshold may be used to determine when it is necessary to monitor the write operations to the tracks in a group on an individual basis.

### FIELD

Embodiments of the present invention relate to the field of data storage, and more particularly relating to adjacent-track-erasure (ATE) refresh.

### BACKGROUND

A disk drive is an information storage device. A disk drive includes one or more disks clamped to a rotating spindle and at least one head for reading information representing data from and/or writing data to the surfaces of each disk. The head is supported by a suspension coupled to an actuator that may be driven by a voice coil motor. Control electronics in the disk drive provide electrical signals to the voice coil motor to move the head to desired positions on the disks to read and write the data in tracks on the disks and to park the head in a safe area when not in use or when otherwise desired for protection of the disk drive.

One problem with disk drives is the potential of data loss experienced by tracks that are adjacent to a track that experiences a high frequency of write operations.

### BRIEF DESCRIPTION OF THE DRAWINGS

FIG. 1 is a perspective view of a magnetic recording and reproducing apparatus (or disk drive) according to an example embodiment.

FIG. 2 is a schematic plan view of a magnetic disk according to an example embodiment.

FIG. 3 is a perspective view of a portion of a magnetic disk according to an example embodiment.

FIG. 4 is a schematic diagram showing a servo zone and a data zone in a magnetic disk according to an example embodiment.

FIG. 5 is a plan view showing patterns in a servo zone and a data zone in a magnetic disk according to an example embodiment.

FIG. 6 is a block diagram of the magnetic recording and reproducing apparatus (disk drive) according to an example embodiment.

FIG. 7 is a schematic plan view of a magnetic disk in operation according to an example embodiment.

FIGS. 8A-8B illustrates different examples of track groups according to an example embodiment.

FIG. 9 is a flow diagram of a method according to an example embodiment.

FIG. 10 is an example block diagram of a computer system for implementing methods and devices as described in accordance with example embodiments.

### DETAILED DESCRIPTION

For some example embodiments, methods of and systems for keeping track of write operations that may affect integrity of information stored on a magnetic disk are disclosed. The tracks on the magnetic disk are divided into groups. A group counter may be used to count the number of write operations to the group, and a track counter may be used to count the number of write operations to the tracks in a selected group.

Other features will be apparent from the accompanying drawings and from the detailed description that follows. In the following description, for purposes of explanation, numerous specific details are set forth in order to provide a thorough understanding of various embodiments. It will be evident, however, to one skilled in the art that the present description may be practiced without these specific details.

Hereinafter, example embodiments of the present invention will be described with reference to the drawings. In the following description, the term adjacent is defined to include locations immediately adjacent and within a nearby distance from an object being discussed.

### Introduction

Protecting the integrity of information stored on a magnetic disk is an important criterion of disk drive manufacturers. As a number of write operations on a particular track increases, the potential of these write operations affecting the integrity of the information stored on the adjacent tracks may increase. This problem is commonly referred to as Adjacent Track Erasure (ATE) problem. To avoid the ATE problem, ATE refresh is performed at the appropriate time. The ATE refresh occurs when the number of write operations reaches a certain threshold. To monitor when the threshold is reached or exceeded, a counter may be used. Since there may be hundreds of thousands of tracks on a magnetic disk, there may be many counters. The amount of memory used to implement these counters may be large (e.g., 1 megabyte or more) and may add to the cost of the disk drive. As will be described, some example embodiments of the present invention may provide techniques to monitor the number of write operations while keeping the amount of memory required and the impact on the performance relatively small

### Hard Disk Assembly (HDA)

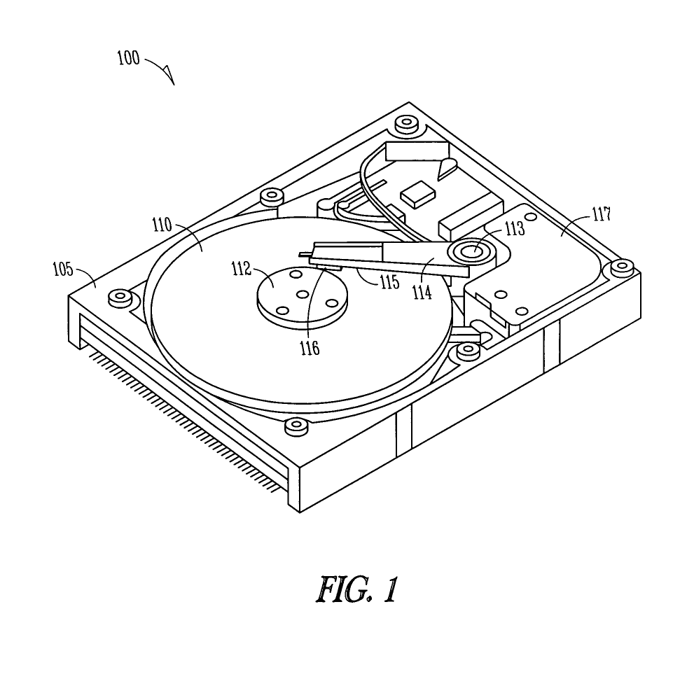

FIG. 1 is a perspective view of a hard disk assembly, according to an example embodiment. Hard disk assembly (HDA) 100 may also be referred to as a magnetic recording and reproducing apparatus. The HDA 100 may be associated with a host computer system (e.g., a personal computer system) and may comprise, inside a chassis 105, a magnetic disk 110, a head slider 116 including a read head and a write head, a head suspension assembly (a suspension 115 and an actuator arm 114) that supports the head slider 116, and a voice coil motor (VCM) 117. A circuit board may be attached to the HDA 100. The HDA 100 may include a head integrated circuit (IC) (also sometimes referred to as a preamp-chip) to generate control signals for controlling read and write operations performed by the magnetic head and to amplify signals read by the head.

The magnetic disk 110 is mounted on and rotated by a spindle motor 112. Various digital data are recorded on the magnetic disk 110. In an example embodiment, the magnetic head incorporated in the head slider 116 is an integrated head including a write head of a single pole structure and a read head using a shielded magneto resistive (MR) read element (such as a GMR film or a TMR film). The suspension 115 is held at one end of the actuator arm 114 to support the head slider 116 to face the recording surface of the magnetic disk 110. The actuator arm 114 is attached to a pivot 113. The voice coil motor (VCM) 117, which drives the actuator, is provided at the other end of the actuator arm 114. The VCM 117 drives the head suspension assembly to position the magnetic head at an arbitrary radial position of the magnetic disk 110.

The circuit board may include a power integrated circuit (often referred to as a “combo-chip) to generate driving signals for the VCM 117 and the spindle motor 112, and a system-chip (often referred to as an “SOC” or “System-On-a-Chip”) which communicates with the host computer system, coordinates the transfer of data between the host computer system, any buffer memory of the disk drive, and the head IC. The SOC generally may contain at least one microprocessor, a read/write channel, a data-controller to facilitate the above-mentioned data-transfers. The SOC may also contain the buffer memory of the disk drive. In some example embodiments, the buffer memory of the disk drive may be contained in another IC, usually a DRAM (Dynamic Random Access Memory). For some example embodiments, the SOC will control that DRAM chip as well.

### Magnetic Disk

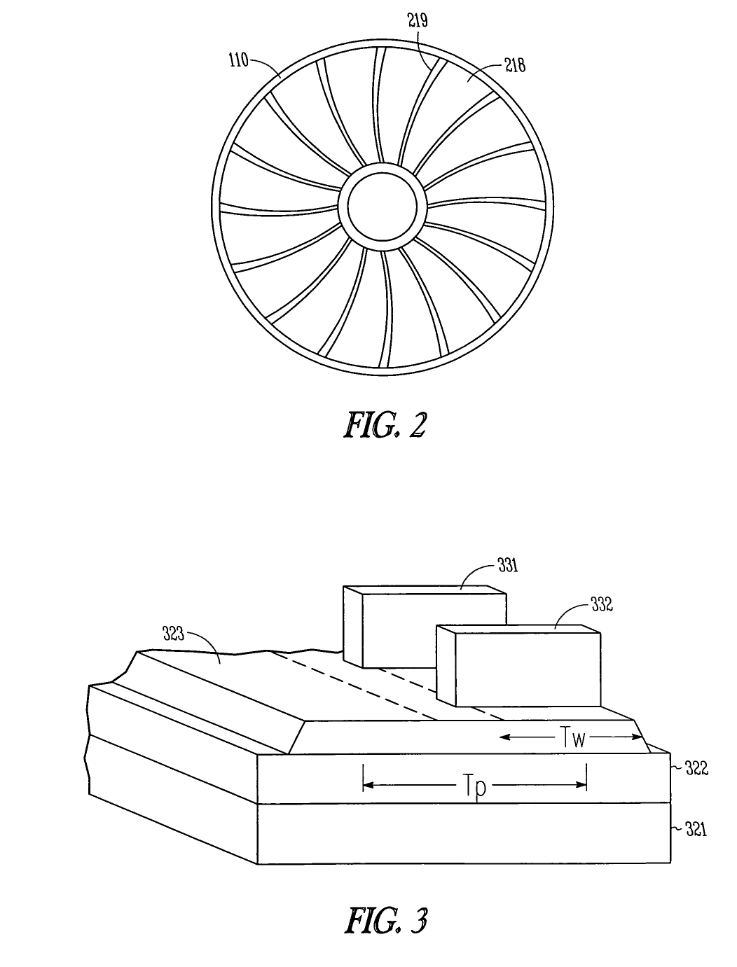

FIG. 2 is a schematic plan view of a magnetic disk 110 according to an example embodiment. FIG. 2 shows data zones 218 and servo zones 219. User data/information is recorded in each of the data zones 218. This example magnetic disk 110 has tracks formed of concentric magnetic patterns. The recording tracks will be described later by way of example with reference to FIG. 3. Servo data for head positioning is formed in each of the servo zones 219 as patterns of a differently magnetized material. In one example embodiment as shown in FIG. 2, each of the servo zones 219 is shaped like a circular arc corresponding to a locus of a head slider during access.

FIG. 3 is a perspective view of one example of a data zone in a magnetic disk media according to an example embodiment. A soft underlayer 322 is formed on a substrate 321 with magnetic patterns constituting the recording tracks 323. The radial width and track pitch of the recording track 323 are denoted as Tw and Tp, respectively. A GMR element 331 of a read head and a single pole 332 of a write head, which are formed in the head slider, are positioned above the recording track 323.

As the substrate 321, a flat glass substrate may be used. The substrate 321 is not limited to the glass substrate but an aluminum substrate (or any other suitable substrate) may be used. A magnetic material is placed onto the substrate 321 and selectively magnetized to form recording tracks. A magnetic material such as CoCrPt may be used, although example embodiments are not so limited. Although not shown, a protective film of diamond-like carbon (DLC) may be formed on the surfaces of the media. In one example, lubricant may be applied to the surface of the protective film.

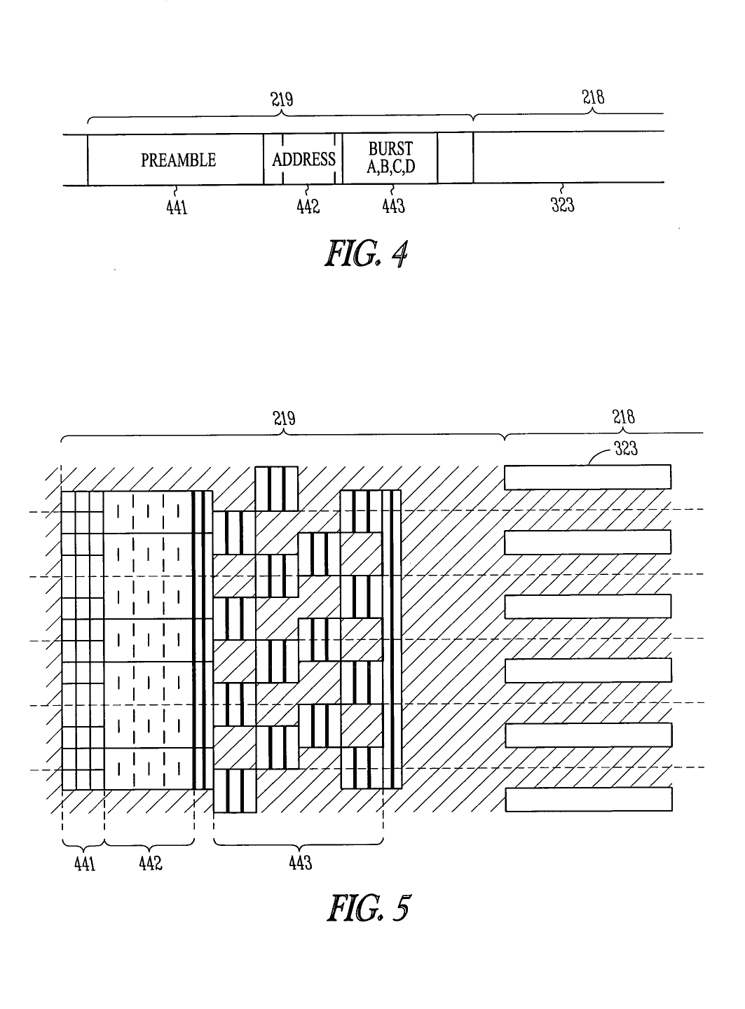

With reference to FIGS. 4 and 5, the patterns of the servo zones 219 and data zones 218 will be described. As schematically shown in FIG. 4, each of the servo zones 219 includes a preamble section 441, an address section 442, and a burst section 443 for detecting deviation.

As shown in FIG. 5, the data zone 218 includes the recording tracks 323. Patterns of the magnetization which provide servo signals are formed in each of the preamble section 441, address section 442, and burst section 443 in the servo zones 219. These sections may have the functions described below.

The preamble section 441 is provided to execute a phase lock loop (PLL) process for synthesizing a clock for a servo signal read relative to deviation caused by relative motions of the heads and media, and an AGC process for maintaining appropriate signal amplitude.

The address section 442 may have servo signal recognition codes called servo-address-marks, sector data, cylinder data, and the like formed at the same pitch as that of the preamble section 441 in the circumferential direction using encoding, for example Manchester, or other types of encoding. The burst section 443 is an example of an off-track detecting region used to detect the amount of off-track with respect to the on-track state for a cylinder address. The burst section 443 includes patterns to locate a read or write head with respect to a desired track center. A pattern in FIG. 5 is shown by way of example including four fields of burst marks (A, B, C, and D), whose patterns in a radial direction are shifted relative to each other in respective fields. Other burst patterns could also be used. In one example, plural marks are arranged at the same pitch as that of the preamble section in the circumferential direction.

The principle of detection of a position on the basis of the burst section 443 will not be described in detail. When using the pattern shown, the off-track amount may be obtained by calculating a function of the average amplitude value of read signals from the A, B, C, and D bursts. As discussed above, other patterns may be used that do not depend on average amplitude.

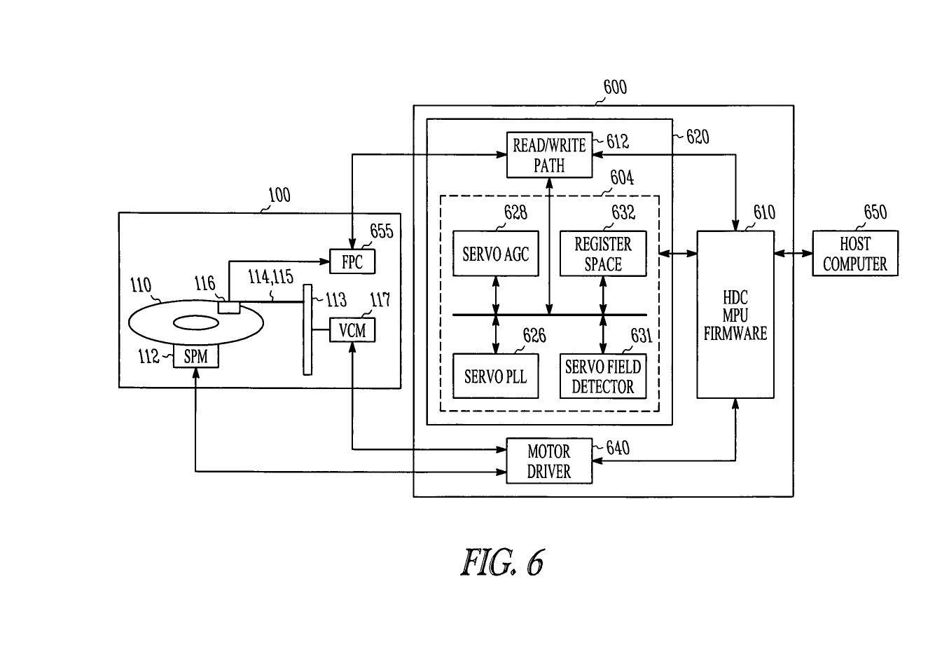

FIG. 6 shows a block diagram of a disk drive with a magnetic disk, according to an example embodiment. Although an example is shown, one of ordinary skill in the art, having the benefit of the present disclosure, will recognize that other device and circuit configurations are possible, and within the scope of the present invention. FIG. 6 shows the head slider 116 only above the top surface of the magnetic disk 110. However, a magnetic recording layer can be formed on each side of the magnetic disk. A down head and an up head may be provided above the bottom and top surfaces of the magnetic disk, respectively. The disk drive includes a main body unit called the HDA 100 and a printed circuit board (PCB) 600.

As shown in FIG. 6, the HDA 100 has the magnetic disk 110, the spindle motor 112, which rotates the magnetic disk 110, the head slider 116, including the read head and the write head, the suspension 115 and actuator arm 114, the VCM 117, and a head amplifier (HIC), which is not shown. The head slider 116 is provided with a read head including a read element, such as a giant magnetoresistive (GMR) element and a write head similar to elements 331 and 332 as shown in FIG. 3.

The head slider 116 may be elastically supported by a gimbal provided on the suspension 115. The suspension 115 is attached to the actuator arm 114, which is rotatably attached to the pivot 113. The VCM 117 generates a torque around the pivot 113 for the actuator arm 114 to move the head in the radial direction of the magnetic disk 110. The HIC is fixed to the actuator arm 114 to amplify input signals to and output signals from the head. The HIC is connected to the PCB 600 via a flexible cable 655. Providing the HIC on the actuator arm 114 may effectively reduce noise in the head signals. However, the HIC may be fixed to the HDA 100.

As described above, the magnetic recording layer is formed on each side of the magnetic disk 110, and the servo zones 219, each shaped like a circular arc, are formed so as to correspond to the locus of the moving head. The specifications of the magnetic disk meet outer and inner diameters and read/write characteristics adapted to a particular drive. The radius of the circular arc formed by the servo zones 219 is given as the distance from the pivot 113 to the magnet head element.

In the illustrated example embodiment, several major electronic components, so-called system LSIs, are mounted on the PCB 600. The system LSIs are a controller 610, a read/write channel IC 620, and a motor driver IC 640. The controller 610 includes a hard disk controller (HDC) and an MPU, and firmware. The MPU is a control unit of a drive system and includes ROM, RAM, CPU, and a logic processing unit that implements a head positioning control system according to the present example embodiment. The logic processing unit is an arithmetic processing unit comprised of a hardware circuit to execute high-speed calculations. Firmware for the logic processing circuit is saved to the ROM or elsewhere in the disk drive. The MPU controls the drive in accordance with firmware. The PCB 600 may include other components as described above with the example of FIG. 1. For example, there may be a buffer RAM, which may be contained in a separate DRAM chip.

Some of the circuits mentioned above may be contained on the same LSI. The HDC is an interface unit in the disk drive which manages the whole drive by exchanging information with interfaces between the disk drive and a host computer 650 (for example, a personal computer) and with the MPU, read/write channel IC 620, and motor driver IC 640.

The read/write channel IC 620 is a head signal processing unit relating to read/write operations. The read/write channel IC 620 is shown as including a read/write path 612 and a servo demodulator 604. The read/write path 612, which can be used to read and write user data and servo data, may include front end circuitry useful for servo demodulation. The read/write path 612 may also be used for self-servowriting. It should be noted that the disk drive also includes other components, which are not shown because they are not necessary to explain the example embodiments.

The servo demodulator 604 is shown as including a servo phase locked loop (PLL) 626, a servo automatic gain control (AGC) 628, a servo field detector 631 and register space 632. The servo PLL 626, in general, is a control loop that is used to provide frequency and phase control for the one or more timing or clock circuits (not shown in FIG. 6) within the servo demodulator 604. For example, the servo PLL 626 can provide timing signals to the read/write path 612. The servo AGC 628, which includes (or drives) a variable gain amplifier, is used to keep the output of the read/write path 612 at a substantially constant level when servo zones 219 on one of the magnetic disks 110 are being read. The servo field detector 631 is used to detect and/or demodulate the various subfields of the servo zones 219, including a SAM (Servo Address Mark), a track number, a first servo burst, and a second servo burst. The MPU is used to perform various servo demodulation functions (e.g., decisions, comparisons, characterization and the like) and can be thought of as being part of the servo demodulator 604. In the alternative, the servo demodulator 604 can have its own microprocessor.

One or more registers (e.g., in register space 632) can be used to store appropriate servo AGC values (e.g., gain values, filter coefficients, filter accumulation paths, etc.) for when the read/write path 612 is reading servo data, and one or more registers can be used to store appropriate values (e.g., gain values, filter coefficients, filter accumulation paths, etc.) for when the read/write path 612 is reading user data. A control signal can be used to select the appropriate registers according to the current mode of the read/write path 612. The servo AGC value(s) that are stored can be dynamically updated. For example, the stored servo AGC value(s) for use when the read/write path 612 is reading servo data can be updated each time an additional servo zone 219 is read. In this manner, the servo AGC value(s) determined for a most recently read servo zone 219 can be the starting servo AGC value(s) when the next servo zone 219 is read.

The read/write path 612 includes the electronic circuits used in the process of writing and reading information to and from the magnetic disks 110. The MPU can perform servo control algorithms, and thus, may be referred to as a servo controller. Alternatively, a separate microprocessor or digital signal processor (not shown) can perform servo control functions.

### Track Spacing

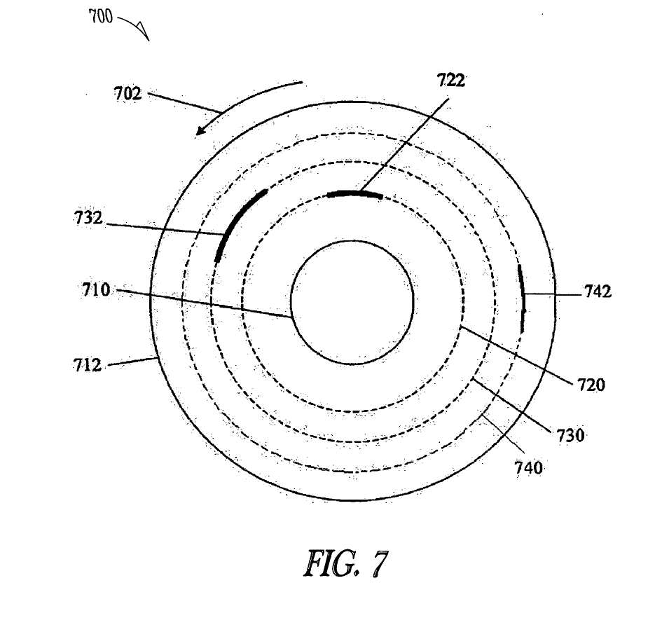

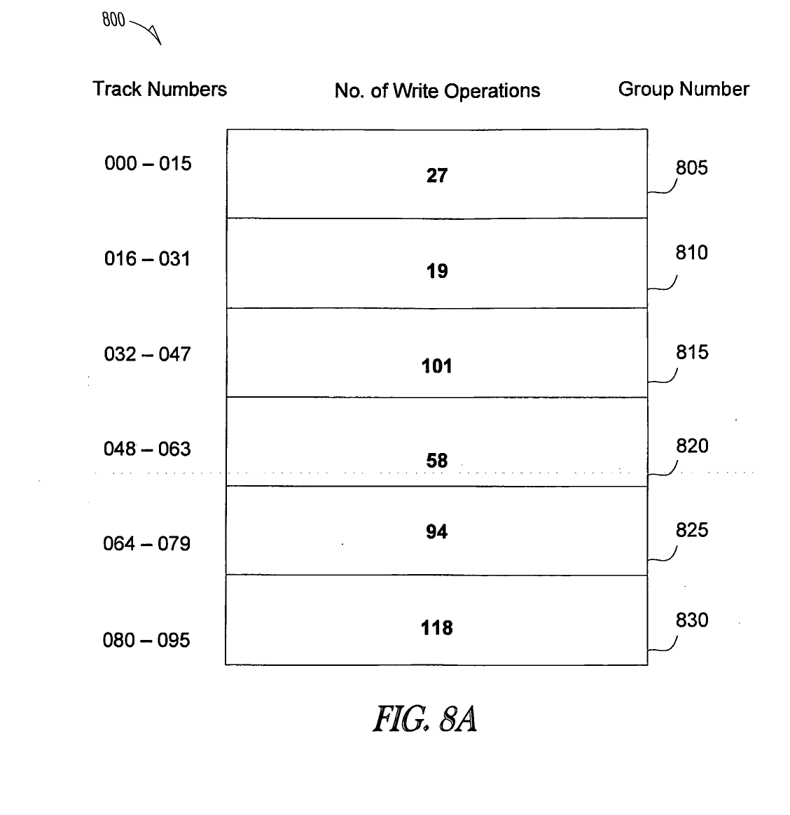

FIG. 7 illustrates a magnetic disk 700 having an inner diameter 710 and an outer diameter 712. During operation, the magnetic disk 700 may be spinning in the direction 702 as indicated in the figure. A first track 720 is shown being adjacent to a second track 730 on an inner radial location. The first track 720 is also shown being adjacent to a third track 740 on an outer radial location. The separation between the tracks in the figure is much larger than the spacing between actual tracks would be in an actual disk drive. This is for purposes of illustration to make it easier for the reader to distinguish the tracks.

In the current example, the first track 720 may include information section 722, the second track 730 may include information section 732, and the third track 740 may include information section 742. The locations of the information sections 722, 732 and 742 are shown for illustrative purposes only, and they may be located anywhere on their corresponding tracks. For example, the information sections 722, 732 and 742 may be located adjacent to one another on their corresponding tracks. Typically, the tracks on the disk 700 may be equally spaced and may be set based on number of tracks per inch (TPI). This is also referred to as track spacing. For example, the track spacing between the tracks 720 and 730 is the same as the track spacing between the tracks 730 and 740. Low TPI means there are fewer tracks per inch (or more space between two adjacent tracks) and thus may correspond to less storage capability. Normal TPI means there are more tracks per inch (or less space between two adjacent tracks) than low TPI and thus may correspond to higher storage capability.

In general, when a track experiences a high frequency of write operations (e.g., a million write operations), the information stored on the adjacent tracks may be affected. The write operations may be related to one or more files being rewritten many times. A predetermined threshold may be used to determine when the number of write operations is considered to be high for the purpose of the ATE refresh. This predetermined threshold may be referred to as an ATE threshold. A software or hardware ATE counter may be used. For example, when the number of times that the information section 732 on the track 730 is written exceeds the ATE threshold, the integrity of the information section 722 and the information section 742 on the adjacent tracks 720 and 740 may be affected. This may be due to the leakage of the magnetic field associated with the write operations. To avoid losing the information on the adjacent tracks, the ATE refresh may be necessary for these adjacent tracks. Any ATE refresh algorithms may be used.

For some example embodiments, the ATE threshold may be set by a disk drive manufacturer. For some example embodiments, the ATE threshold may be subsequently modified by software and/or hardware installed in the disk drive by the disk drive manufacturer.

Track spacing may have a large influence on whether there is a need to perform the ATE refresh. One approach is to use low TPI for all tracks to reduce the need for the ATE refresh; however, that comes with the cost of storage capacity. Another approach is to use normal TPI for all tracks and perform the ATE refresh more frequently (e.g., after each ten thousand write operations) to avoid losing the information on the adjacent tracks; however, that comes with the cost of overhead and performance. In general, when using low TPI (the track spacing is high), the susceptibility to ATE is reduced.

### Track Counters

In order to monitor the number of write operations to a track, a counter may be used. This counter may be referred to as a track counter. Each track counter may be associated with a register or a memory address. Since there may be hundreds of thousands of tracks in a magnetic disk, having one track counter per track may be inefficient and may require a large amount of memory. For example, if the disk drive has 400,000 tracks, and each track counter requires two bytes of memory, then having a track counter for each track would require 800,000 bytes (2 times 400,000) of memory.

### Track Groups and Group Counters

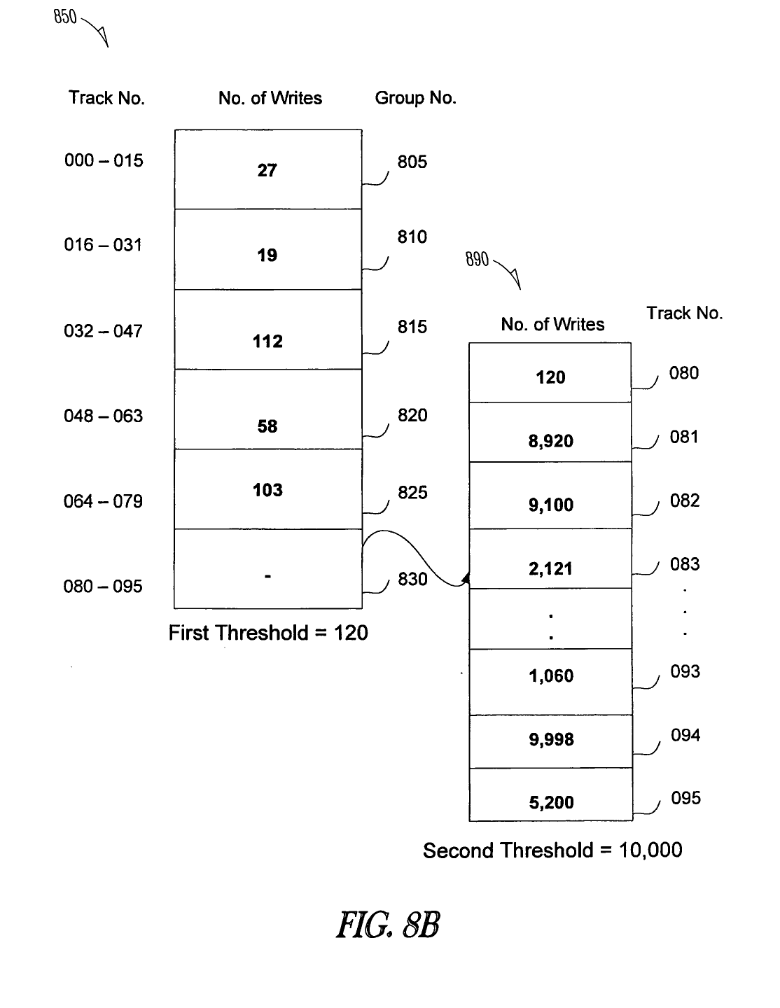

FIG. 8A is a block diagram that illustrates an example of track groups, in accordance with some example embodiments. Table 800 includes six groups of tracks 805-830. Each of the group of tracks 805-830 may include 16 tracks. For example, the group 805 includes track number 000 to 015, and the track 830 includes track number 080-095. Each group of tracks may be associated with a number of write operations. For example, the group 810 may be associated with 19 write operations, and the group 820 may be associated with 58 write operations. One reason for using track groups is that the size of memory required to implement the counters based on the track groups (also referred to as group counters) may be less than if the track counters are implemented.

One known technique of monitoring the number of write operations is to use a group counter for odd-numbered tracks in a group and a different group counter for even-numbered tracks in the group. When the number of write operations to the even-numbered tracks exceeds a threshold, the ATE refresh may be applied to all of the odd-numbered tracks in the group, and vice-versa. Thus, when a disk drive has 400,000 tracks, and there are 16 tracks per group, there would be 25,000 groups (400,000 divided by 16). In the current example, since there are a group counter for odd-numbered tracks and a group counter for even numbered tracks, and since each group counter requires two bytes of memory, the total amount of memory required is 100,000 bytes (25,000 times two group counters times 2 bytes). This is less than the 800,000 bytes required when using the track counter for each individual track.

### Group Counters and Track Counters

FIG. 8B is a block diagram that illustrates another example of track groups, in accordance with some example embodiments. Table 850 in the current example is similar to the table 800 of the example in FIG. 8A. For some example embodiments, a group counter may be used to monitor the number of write operations to all of the tracks in a group. Alternative embodiments of monitoring the number of write operations to the even tracks or to the odd tracks may also be used.

For some example embodiments, when the group counter reaches or exceeds a group threshold, a track counter may be used to monitor the number of write operations to each of the individual tracks in that group. Referring to the table 850, when the number of write operations to the tracks in the group 830 reaches the group threshold (e.g., 120), the number of write operations to each of the tracks 080-095 may be individually monitored, as illustrated by table 890. For some example embodiments, memory associated with monitoring the number of write operations to the individual tracks may be allocated after the group counter reaches or exceeds the group threshold (referred to as the first threshold in table 850). It may be noted that the number of bits required to implement the group counter may be based on the group threshold. For example, when the group threshold is 120, as in the current example, the number of bits required to implement the group counter is seven (7). Thus, since there are 8 bits in a byte, one bit is not used. For some example embodiments, an indicator may be used to indicate whether the number of write operations to the tracks in a group is being monitored as a group or on a track-by-track basis. For some example embodiments, the indicator may be implemented using the unused bit from the byte that is used to implement the group counter. It may be noted that by using one bit for the indicator (referred to herein as an indicator bit), the group threshold may be limited to a value of up to 127 (using the remaining seven (7) bits) instead of up to 255 (using all eight (8) bits). For some example embodiments, the indicator bit may be set to “1” when the tracks in a group are being individually monitored and set to “0” otherwise. When the bit is set to “1”, the remaining seven (7) bits in the byte that had previously been used to keep track of the number of write operations to the group may be replaced by a value that may be used to determine the location (or address) of a table where the number of write operations to each track are being kept track of. For example, the byte associated with the group 830 may have a value “10101110”, where the left most significant bit “1” indicates that the remaining seven bits of “0101110” may be used to determine an address associated with the table 890. For example, the seven (7) bits may be up-shifted by five (5) bits and then added to by an offset to determine an address. Using the example scheme described herein would limit the number of secondary tables (similar to the table 890) to 128. If two bytes were allocated to each of the group counters, then the first threshold would be limited to a value of 32767 (or 2¹⁵-1), and up to 32768 secondary tables may be possible.

For some example embodiments, the number of tracks per group may be the same, or they may be different. It may be noted that although the current example illustrates using a byte to implement the group threshold, it may be possible to use more than one byte for a higher group threshold value.

For some example embodiments, the number of write operations to each of the tracks may be initially set to the same value when the tracks are to be individually monitored. For some example embodiments, this initial value may be the same as the value of the group threshold. As illustrated by the example tables 850 and 890, the initial number of write operations assigned to each of the tracks 080-095 in the group 830 may be 120 which is the value of the group threshold in the current example. For illustrative purposes, the track 080 in the table 890 is associated with 120 write operations which may indicate that the value was not modified since its initial setting. For some example embodiments, the initial value may be set to zero or to any number as long as the initial values are the same for all of the tracks in the group. The initial value may be used to determine when the ATE refresh is necessary.

For some example embodiments, a track threshold (referred to as a second threshold in the table 890) may be used to determine when the number of write operations is high enough that the ATE refresh is necessary. For example, the track threshold may be set to a value of 10,000 indicating that when the number of write operations to a particular track reaches or exceeds 10,000, the ATE refresh for the adjacent tracks may be performed. For some example embodiments, the value of the group threshold may be small comparing to the value of the track threshold. It may be noted that when the value of the track threshold is small, the ATE refresh may be performed long before any possibly-damaged information becomes un-readable. It may also be noted that when the value of the track threshold is small, the number of bytes required to implement the track counter may also be small. In the current example, only two bytes may be required to implement a track counter when the track threshold is 10,000.

The technique of monitoring the individual tracks in addition to monitoring the group of tracks improves over the technique that requires the ATE refresh to be performed for all of the even tracks or all of the odd tracks in a group. When the number of write operations to the tracks in a group is evenly spread-out, the ATE refresh may be performed less frequently. This is because a write operation to a track (e.g., track 080 in the table 890) will only affect the track counter for that particular track and not the group counter for the associated group (e.g., group 830). When the number of write operations to the tracks in a group is concentrated on one particular track (e.g., track 094), the ATE refresh may be performed only for the adjacent tracks (e.g., 093 and 095) and not all the odd or even tracks in the group or tracks that are not adjacent to the track has many write operations. When the number of groups that exceed the group threshold is small, the amount of memory used to monitor the write operations may be small because the number of tracks that are monitored individually is small.

Resetting the Track Counters and/or Group Counter

For some example embodiments, when the ATE refresh is performed, the track counter for the track that causes the ATE refresh may be reset. The reset value may be zero. For example, when the number of write operations to the track 094 reaches the 10,000 threshold, the ATE refresh may be performed for the adjacent tracks 093 and 095. The track counter for the track 094 may then be reset to zero. For some example embodiments, when the values of the track counters of all of the tracks in a particular group are less than the group threshold, it may not be necessary to monitor the individual tracks. In these situations, a highest value of all of the track counters in the group may be used as the group counter for that group. The indicator may be reset to a value corresponding to not monitoring the individual tracks.

For some example embodiments, when the tracks in a group are monitored on a track-by-track basis, it may be possible to refresh all the tracks in the group when one or more certain criteria are met. For example, this may occur when all of the track counters are within 50% of the track threshold. As another example, this may occur when there is a group that has a track counter having a highest value. As yet another example, this may occur when there is a group that has a highest total value of all the values of the track counters. After all the tracks are refreshed, the group counter for the associated group may be reset. For some example embodiments, refreshing all the tracks in a group may be performed when the memory is low due to memory allocated to the various track counters. Other techniques to select a group to be refreshed and to reset the group counter may also be used.

The methods and systems described herein may require allocation of memory to monitor the write operations on a group-by-group basis, and when necessary allocation of additional memory to monitor the write operations on a track-by-track basis. It may be noted that the memory allocated when monitoring a group of tracks on the track-by-track basis may be de-allocated when it is no longer necessary.

### Flow Diagram

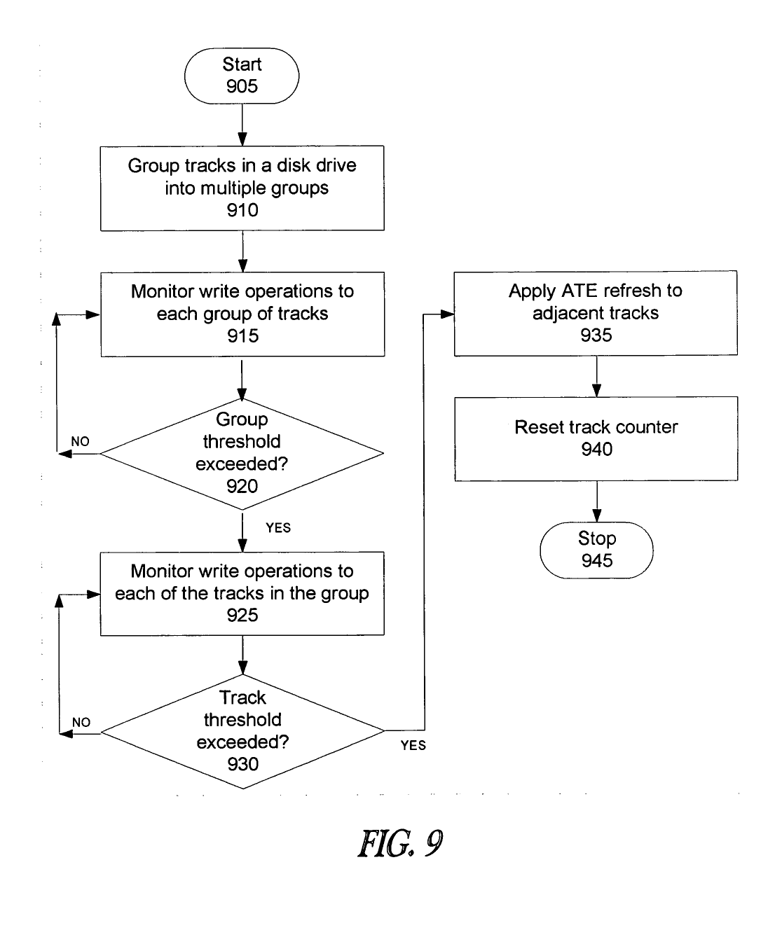

FIG. 9 illustrates an example flow diagram as described in some example embodiments described herein. The flow diagram may be related to a method or a process that may be used to perform operations to help reducing the need for frequent ATE refresh and/or memory associated with monitoring the write operations. The process may start at block 905. At block 910, the tracks on a magnetic disk are divided into groups of tracks. As noted above, the number of tracks in the groups may be the same, or they may be different. For each group, a group counter may be used to monitor the write operations to the group, as shown in block 915.

At block 920, it is determined whether the number of write operations to any of the groups exceed (or reach) the group threshold. If there is such a group, the process may continue to block 925 where the number of write operations to the individual tracks in that group is monitored. A track counter may be used for each of the tracks. An initial value may be assigned to each of the track counters. From block 920, if there is no such group, the process may continue to monitor the groups at block 915.

At block 930, it is determined whether the number of write operations to any of the tracks in the group exceed (or reach) a track threshold. If there is no such track, the process may continue at block 925. If there is such a group, then the process may continue to monitor the tracks at block 925.

From block 930, if there is such a track, the process may continue at block 935, where the ATE refresh may be performed to the tracks that are adjacent to the track located in block 930. At block 940, the track counter for the track located by the operations of block 930 may be reset. The process may stop at block 945. It may be noted that the process described above with FIG. 9 may be repeated many times for continuous monitoring. It may be noted that the methods and systems described herein may be implemented in software, hardware or a combination of both. For example, the disk drive controller may execute instructions performing logic that groups the tracks, monitors the number of write operations to the groups/tracks, performs the ATE refresh, allocates and de-allocates memory, and so on.

It is possible that the tracks in a magnetic disk of a disk drive may be associated with different track spacing or track-per-inch (TPI) regions. For example, there may be a low TPI region and a normal TPI region. It may be noted that the process described herein may be applied with a magnetic disk with tracks associated with a single TPI region or multiple TPI regions.

### Computer System

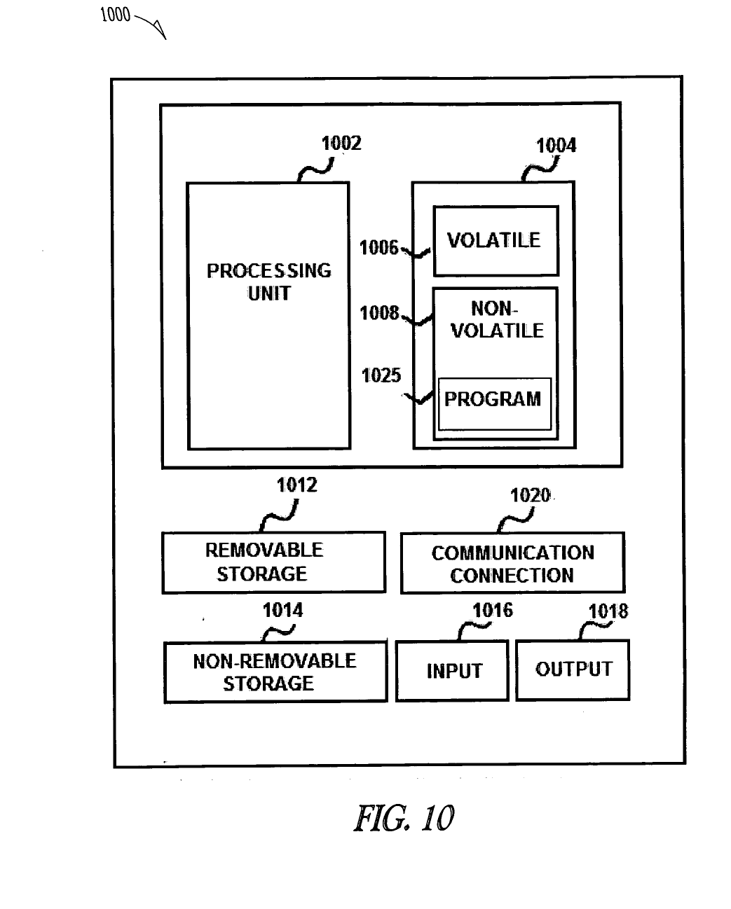

FIG. 10 illustrates an example computer system that may be used, in accordance with some example embodiments. Software to calculate and perform the drive operations as described above is typically stored in firmware within the hard drive although example embodiments are not so limited. Computer system 1000 may be used to execute instructions to perform methods as described. The computer system 1000 may include a processing unit 1002, memory 1004, removable storage 1012, and non-removable storage 1014. The memory 1004 may include volatile memory 1006 and non-volatile memory 1008. Computer system 1000 may include—or have access to a computing environment that includes—a variety of computer-readable media, such as volatile memory 1006 and non-volatile memory 1008, removable storage 1012 and non-removable storage 1014. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer system 1000 may include or have access to a computing environment that includes input 1016, output 1018, and a communication connection 1020. The computer system 1000 may operate in a networked environment using the communication connection 1020 to connect to one or more remote computers. The remote computer may include a personal computer (PC), server, router, network PC, a peer device or other common network node, or the like. The communication connection 1020 may include a Local Area Network (LAN), a Wide Area Network (WAN) or other networks. The controller 610 (described above in the example in FIG. 6) or other selected circuitry or components of the disk drive may be such a computer system.

In the current example, computer program 1025 may be stored in non-volatile memory 1008. In some situations, the computer program 1025 may be stored in volatile memory 1006. The computer program 1025 may include computer-readable instructions and may be stored on a computer-readable medium and executable by the processing unit 1002 of the computer system 1000. A disk drive, CD-ROM, and RAM are some examples of articles including a computer-readable medium. As mentioned above, the computer program 1025 may also be termed firmware associated with the disk drive. In some example embodiments, a copy of the computer program 1025 can also be stored on the magnetic disk 110 of the HDA 100 (described above).

The foregoing description of the specific example embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed example embodiments.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A hard disk assembly (HDA) apparatus comprising:
at least one disk;
a spindle motor coupled to the disk; and
a read/write head to read information from and to write information to a plurality of tracks on the disk, wherein the plurality of tracks are grouped into multiple groups of tracks, wherein a number of write operations to tracks in a first group is monitored on a track-by-track basis when the number of write operations to the first group reaches or exceeds a first threshold.

2. The apparatus of claim 1, wherein when the number of write operations is monitored on the track-by-track basis and a number of write operations to a first track reaches or exceeds a second threshold, adjacent-track-erasure (ATE) refresh is performed to tracks adjacent to the first track.

3. The apparatus of claim 2, wherein a first counter is used to monitor the write operations to the first group.

4. The apparatus of claim 3, wherein a second counter is used to monitor the write operations to the first track.

5. The apparatus of claim 4, wherein the second counter is set to an initial value equal to a value associated with the first threshold when the first threshold is reached or exceeded.

6. The apparatus of claim 5, wherein the second counter is reset responsive to the ATE refresh.

7. The apparatus of claim 4, wherein one or more bytes of memory of the HDA are used to implement an indicator bit and to determine either the first counter or a location associated with the second counter.

8. The apparatus of claim 7, wherein the indicator bit is used to indicate whether the remaining bits are used to determine either the first counter or the location associated with the second counter.

9. The apparatus of claim 8, wherein the memory location associated with the second counter is de-allocated when the number of write operations to the first group is monitored as a group instead of on the track-by-track basis.

10. A method of reducing need for adjacent track erasure (ATE) refresh in a disk drive comprising:
grouping tracks of a magnetic disk into multiple groups including a first group;
monitoring a number of write operations to the first group; and
when the number of write operations to the first group reaches or exceeds a first threshold, monitoring a number of write operations to each of the tracks in the first group.

11. The method of claim 10, further comprising:
responsive to the first threshold being reached or exceeded, initializing the number of write operations to each of the tracks in the first group to a value associated with the first threshold.

12. The method of claim 11, further comprising:
when a number of write operations to a first track of the first group reaches or exceeds a second threshold, performing adjacent track erasure (ATE) refresh for tracks adjacent to the first track.

13. The method of claim 12, further comprising:
resetting the number of write operations to the first track responsive to said performing the ATE refresh.

14. The method of claim 12, further comprising:
allocating one or more bytes of memory of the disk drive to implement an indicator bit and, based on a value of the indicator bit, either to determine the number of write operations to the first group or a location associated with the number of write operations to the first track.

15. The method of claim 10, wherein the multiple groups includes a second group, and wherein said monitoring the number of write operations to each of the tracks in the first group is performed while monitoring a number of write operations to the second group.

16. A system comprising:
a processor;
a memory coupled to the processor; and
a disk drive coupled to the memory, the disk drive including a magnetic disk configured with multiple tracks, the disk drive including logic to group the multiple tracks into multiple groups and a first logic to:
monitor a number of write operations to a first group of tracks;
when the number of write operations to the first group reaches or exceeds a first threshold, monitor a number of write operations to each of the tracks in the first group instead of monitoring the number of write operations to the first group.

17. The system of claim 16, wherein the disk drive comprises a second logic to perform adjacent-track-erasure (ATE) refresh to tracks adjacent to a first track of the first group when the number of write operations to the first track reaches or exceeds a second threshold.

18. The system of claim 17, further comprising:
logic to allocate memory to enable monitoring the number of write operations to the first track responsive to the first threshold being reached or exceeded.

19. The system of claim 18, further comprising:
logic to de-allocate the memory and to reset the number of write operations to the first group when the ATE refresh is applied to all of the tracks in the first group.
